(19) United States
(12) Patent Application Publication
(10) Pub. No.: US 2020/0372549 A1
(43) Pub. Date: Nov. 26, 2020

(54) ADVERTISEMENT SYSTEM, CONTROL APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventors: Hideki KATO, MATSUMOTO-SHI (JP); Kan MATSUDA, SHIOJIRI-SHI (JP); Tomomi MIYASAKA, OKAYA-SHI (JP)

(21) Appl. No.: 16/877,601

(22) Filed: May 19, 2020

(30) Foreign Application Priority Data
May 22, 2019 (JP) 2019-095789

(51) Int. Cl. G06Q 30/02; G06F 3/12; G06Q 50/28; G06Q 10/06; G05B 15/02

(52) U.S. Cl. CPC G06Q 30/0276; G06F 3/129; G05B 15/02; G06Q 50/28; G06Q 10/06316; G06F 3/1272

(57) ABSTRACT

An advertisement system issues a flyer by using a printer through communication between a tablet terminal and a posting server. The tablet terminal detects a current position and transmits current position information indicating the detected current position to the posting server. The posting server receives the current position information from the tablet terminal, and selects advertisement images based on the current position indicated by the received current position information from a plurality of advertisement images acquired from advertisers. The posting server then creates print data involved in printing the selected advertisement images, and transmits the created print data to the tablet terminal. The tablet terminal receives the print data and causes the printer to execute printing based on the received print data.

The present application is based on, and claims priority from JP Application Serial Number 2019-095789, filed May 22, 2019, the disclosure of which is hereby incorporated by reference herein in its entirety.

### BACKGROUND

### 1. Technical Field

The present disclosure relates to an advertisement system, a control apparatus, a non-transitory computer-readable storage medium storing a program, and a method of controlling the advertisement system.

### 2. Related Art

A technology known in related art issues an advertisement medium on which an advertisement image is printed by a printing apparatus. For example, JP-A-2005-259018 discloses a system that receives image information for use for an advertisement from an advertiser and edits the image information to create design information about an advertisement, after which the technology creates print information according to the created design information, executes printing based on the created print information at a location at which the advertisement is distributed, and issues a flyer.

The demand on a flyer as described in JP-A-2005-259018 is to vary advertisements to be placed on the flyer depending on the distribution destination so that the advertisement effect for the distribution destination is increased. With the system described in JP-A-2005-259018, however, it is difficult to vary advertisements to be placed on a flyer in a distribution area including a distribution location.

### SUMMARY

An aspect to solve the above problem is an advertisement system in which a server and a control apparatus that controls a printing apparatus mutually communicate to issue an advertisement medium by using the printing apparatus, advertisement images being printed on the advertisement medium. The control apparatus detects a current position and transmits current position information indicating the detected current position to the server. The server receives the current position information from the control apparatus, selects advertisement images based on the current position indicated by the received current position information from a plurality of advertisement images acquired from advertisers, creates print data involved in printing the selected advertisement images, and transmits the created print data to the control apparatus. Upon receipt of the print data, the control apparatus causes the printing apparatus to execute printing based on the received print data.

In the advertisement system, the server may determine a sequence of distribution destinations to which to distribute the advertisement medium. When the distribution of the advertisement medium has been completed at a first distribution destination, the printing apparatus or control apparatus may transmit the current position information to the server. The server may create the print data for the advertisement medium to be distributed to a second distribution destination, which is a next distribution destination after the first distribution destination, according to the determined sequence and the current position information received from the printing apparatus or control apparatus.

In the advertisement system, the server may transmit information indicating the determined sequence to the control apparatus, and the control apparatus may indicate the information indicating the sequence.

In the advertisement system, the printing apparatus may include the control apparatus.

Another aspect to solve the above problem is a control apparatus that controls a printing apparatus. The control apparatus has a first communication section that communicates with the printing apparatus, a second communication section that communicates with a server, a position detecting section that detects a current position, and a control section that controls the first communication section, second communication section, and position detecting section. The control section transmits current position information indicating the current position detected by the position detecting section to the server through the second communication section, receives print data from the server through the second communication section, the print data being involved in printing advertisement images selected by the server from a plurality of advertisement images acquired from advertisers according to the current position, and transmits the received print data to the printing apparatus through the first communication section to have the printing apparatus execute printing based on the print data.

Yet another aspect to solve the above problem is a non-transitory computer-readable storage medium storing a program executable by a control section in a control apparatus having a first communication section that communicates with a printing apparatus, a second communication section that communicates with a server, and a position detecting section that detects a current position. The program causes the control section to transmit current position information indicating the current position detected by the position detecting section to the server through the second communication section, to receive print data from the server through the second communication section, the print data being involved in printing advertisement images selected by the server from a plurality of advertisement images acquired from advertisers according to the current position, and to transmit the received print data to the printing apparatus through the first communication section.

Still another aspect to solve the above problem is a method of controlling an advertisement system in which a server and a control apparatus that controls a printing apparatus mutually communicate to issue an advertisement medium by using the printing apparatus, advertisement images being printed on the advertisement medium. The control apparatus detects a current position and transmits current position information indicating the detected current position to the server. The server receives the current position information from the printing apparatus or control apparatus, selects advertisement images based on the current position indicated by the received current position information from a plurality of advertisement images acquired from advertisers, creates print data involved in printing the selected advertisement images, and transmits the created print data to the control apparatus. Upon receipt of the print data, the control apparatus causes the printing apparatus to execute printing based on the received print data.

### BRIEF DESCRIPTION OF THE DRAWINGS

FIG. 1 illustrates the structure of an advertisement system.

FIG. 2 illustrates the structures of apparatuses included in the advertisement system.

FIG. 3 illustrates an example of a distributor management database.

FIG. 4 illustrates an example of a request information management database.

FIGS. 5A and 5B are flowcharts illustrating the operation of the advertisement system.

FIG. 6 illustrates the operations of a posting server and a tablet terminal.

### DESCRIPTION OF EXEMPLARY EMBODIMENTS

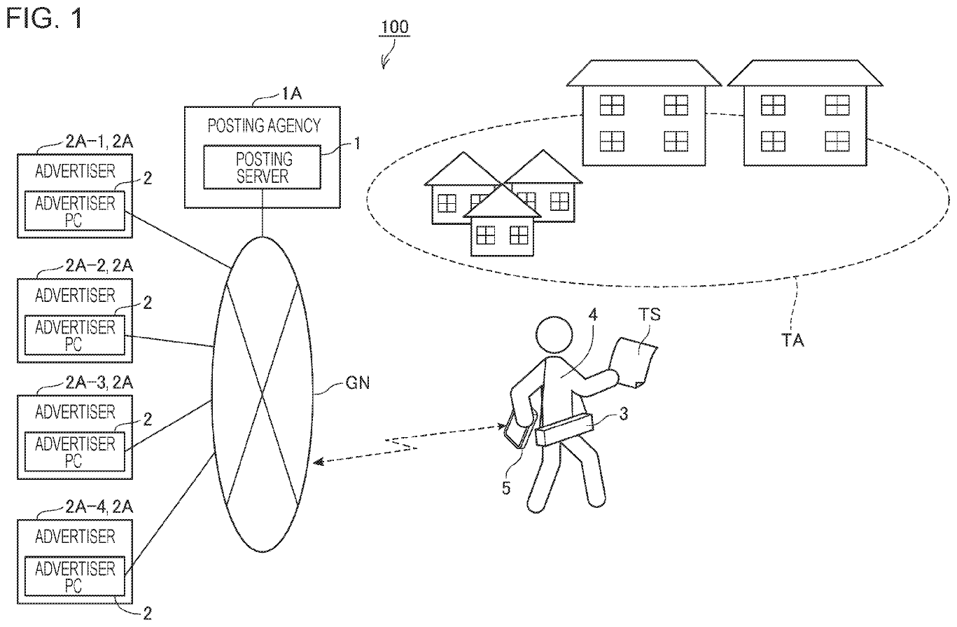

FIG. 1 illustrates the structure of an advertisement system 100. The advertisement system 100 is used by a posting agency 1A. The posting agency 1A performs a business operation involved in distributing a flyer TS on which advertisements of a product, service, and the like of an advertiser 2A are placed. The flyer TS is a drawing indicating an example of an advertisement medium.

As illustrated in FIG. 1, the advertisement system 100 has a posting server 1. The posting server 1, which is a server apparatus managed by the posting agency 1A, is coupled to a global network GN such as the Internet. The posting server 1 is equivalent to an example of a server. Although, in the drawings, the posting server 1 is represented by a single block, this does not necessarily mean that the posting server 1 is a single server apparatus. For example, the posting server 1 may be structured by including a plurality of server apparatuses that execute different types of processing.

As illustrated in FIG. 1, the advertisement system 100 has a printer 3, which is equivalent to an example of a printing apparatus. The printer 3 in this embodiment is a printing apparatus in a continuous ink supply system (CISS), in which an ink tank from which ink is supplied to an ink jet head can be replenished with the ink ex post facto. The printer 3 in this embodiment is exemplified by a portable printing apparatus that can be carried by a distributor 4 who has a predetermined contract with the posting agency 1A to distribute a flyer TS. The printer 3 may be owned by the distributor 4 or may be rented from the posting agency 1A.

In FIG. 1, one distributor 4 is illustrated. In this embodiment, the distributors 4 in FIG. 1 is a distributor 4 to whom an area A is assigned as an assigned area TA in which the distributor 4 takes charge of distributing the flyer TS. Although not illustrated, distributors 4 having contract with the posting agency 1A include distributors 4 assigned to areas other than the area A. Although one distributor 4 is assigned to the area A, this is just an example. A plurality of distributors 4 may be assigned to the area A without being limited to one distributor 4.

As illustrated in FIG. 1, the advertisement system 100 has a tablet terminal 5 used by the distributor 4. The tablet terminal 5 is equivalent to an example of a control apparatus. The tablet terminal 5 is, for example, a tablet-type terminal apparatus having a touch panel 53 in a wide area on the front surface. The tablet terminal 5 communicates with the printer 3 and controls the printer 3. The tablet terminal 5 used by the distributor 4 may be a tablet terminal owned by the distributor 4 or a tablet terminal rented from the posting agency 1A. In this embodiment, a case is exemplified in which one printer 3 communicates with one tablet terminal 5. However, a plurality of printers 3 may communicate with the tablet terminal 5.

As illustrated in FIG. 1, a plurality of advertiser PCs 2, each of which is operated by one advertiser 2A, are coupled to the global network GN. In this embodiment, a case is exemplified in which four advertiser PCs 2 are coupled to the global network GN. A browser is preinstalled in each advertiser PC 2. The advertiser 2A activates the browser installed in the advertiser PC 2 and accesses a Web page provided by the posting agency 1A to request the posting agency 1A to distribute a flyer TS through the Web page. Although four advertiser PCs 2 are coupled to the global network GN, this is just an example. More advertiser PCs 2 or less advertiser PCs 2 may be coupled to the global network GN without being limited to four advertiser PCs 2.

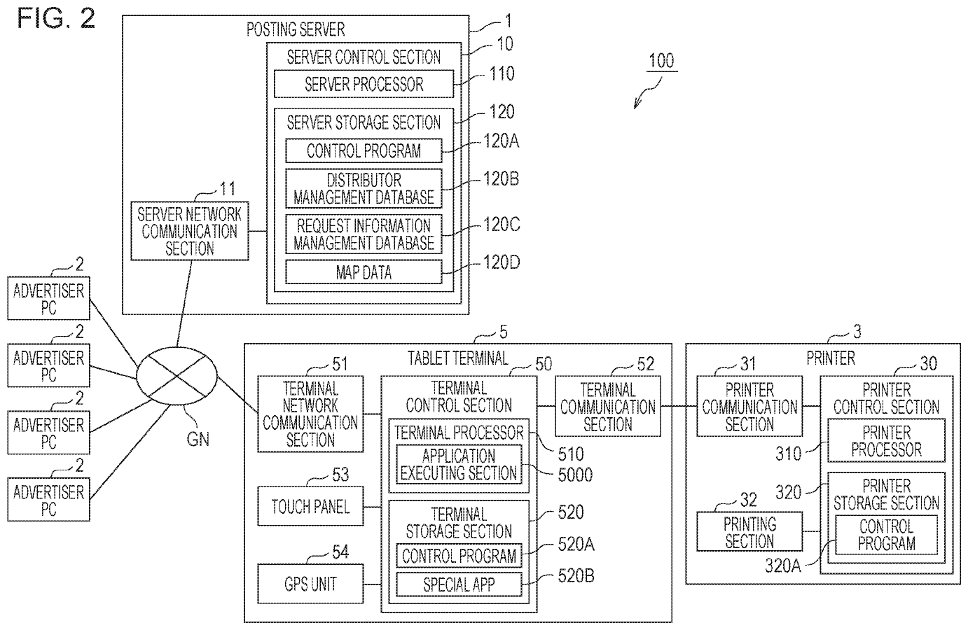

FIG. 2 is a block diagram illustrating the functional structures of apparatuses included in the advertisement system 100.

The posting server 1 has a server control section 10 and a server network communication section 11.

The server control section 10 has a server processor 110, which is a processor, such as a central processing unit (CPU) or a microprocessor unit (MPU), that executes programs, and also has a server storage section 120. The server control section 10 controls individual sections in the posting server 1. To have the server processor 110 read a control program 120A stored in the server storage section 120 and execute processing, the server control section 10 executes various types of processing in cooperation with hardware and software.

The server storage section 120 has a storage area in which programs to be executed by the server processor 110 and data to be processed by the server processor 110 are stored. The server storage section 120 stores the control program 120A to be executed by the server processor 110, a distributor management database 120B, a request information management database 120C, map data 120D, and various other types of data. The server storage section 120 has a non-volatile storage area that stores programs and data in a non-volatile manner. The server storage section 120 may also have a volatile storage area to form a work area that temporarily stores programs to be executed by the server processor 110 and data to be processed.

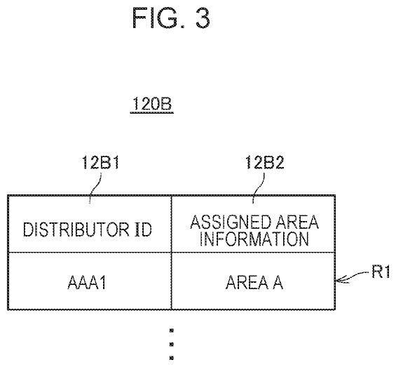

FIG. 3 illustrates an example of the distributor management database 120B.

One record in the distributor management database 120B includes a distributor identifier (ID) 12B1 and assigned area information 12B2.

In FIG. 3, the record R1 is a record for the distributor 4 illustrated in FIG. 1. The distributor management database 120B has records for other distributors 4 having a predetermined contract with the posting agency 1A besides the record R1.

The distributor ID 12B1 is identification information that identifies the distributor 4. When a new record is to be stored in the distributor management database 120B, the distributor ID 12B1 is assigned to the distributor 4.

Assigned area information 12B2 indicates an assigned area in which the distributor 4 distributes a flyer TS. When a record is to be stored in the distributor management database 120B, assigned area information 12B2 is set by the distributor 4 or posting agency 1A.

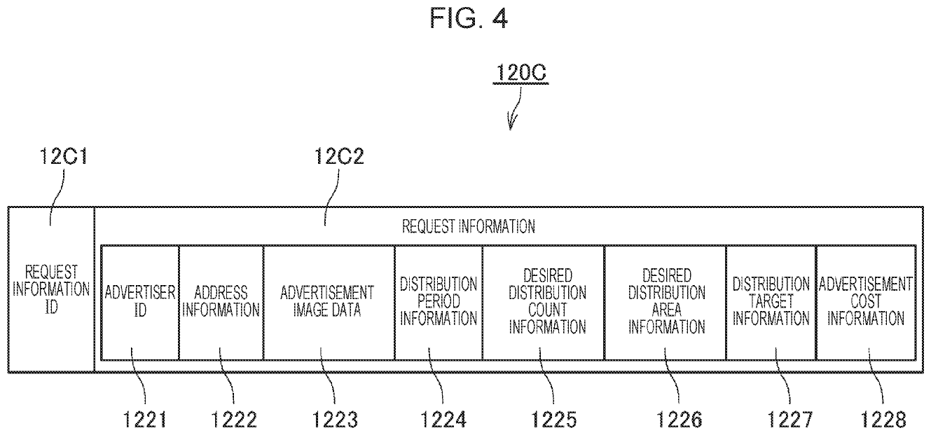

FIG. 4 schematically illustrates information included in one record in the request information management database 120C.

As illustrated in FIG. 4, one record in the request information management database 120C includes a request information ID 12C1 and request information 12C2.

Request information ID 12C1 is identification information that identifies request information 12C2 received from the advertiser PC 2. Request information 12C2 will be described later.

When the server control section 10 in the posting server 1 receives request information 12C2 from the advertiser PC 2 through the server network communication section 11, the server control section 10 creates request information ID 12C1 and associates the created request information ID 12C1 with the received request information 12C2. The server control section 10 then stores, in the request information management database 120C, a record in which the request information ID 12C1 is associated with the request information 12C2.

Map data 120D includes road map information indicating roads on a map and position information about buildings, parks, and the like.

The server network communication section 11 has communication hardware complying with a predetermined communication standard. Under control of the server control section 10, the server network communication section 11 communicates with devices coupled to the global network GN according to the predetermined communication standard. The devices, referred to here, coupled to the global network GN include advertiser PCs 2 and the tablet terminal 5. Examples of the communication standard used by the server network communication section 11 for communication include the Hypertext Transfer Protocol (HTTP) and WebSocket.

The tablet terminal 5 has a terminal control section 50, a terminal network communication section 51, a terminal communication section 52, the touch panel 53, and a Global Positioning System (GPS) unit 54. The terminal control section 50 is equivalent to an example of a control section. The terminal network communication section 51 is equivalent to an example of a second communication section. The terminal communication section 52 is equivalent to an example of a first communication section. The GPS unit 54 is equivalent to an example of a position detecting section.

The terminal control section 50 has a terminal processor 510, which is a processor, such as a CPU or MPU, that executes programs, and also has a terminal storage section 520. The terminal control section 50 controls individual sections in the tablet terminal 5. To have the terminal processor 510 read a control program 520A stored in the terminal storage section 520 and execute processing, the terminal control section 50 executes various types of processing in cooperation with hardware and software. A special application program is preinstalled in the tablet terminal 5. In the description below, the special application program will be simply referred to as the special app 520B. The special app 520B is equivalent to an example of a program. When the special app 520B is read from the terminal storage section 520 by the terminal processor 510 and is executed by it, the special app 520B causes the terminal control section 50 to function as an application executing section 5000. Functions of the application executing section 5000 will be described later.

The terminal storage section 520 has a storage area in which programs to be executed by the terminal processor 510 and data to be processed by the terminal processor 510 are stored. The terminal storage section 520 stores the control program 520A to be executed by the terminal processor 510, the special app 520B, and various types of data. The terminal storage section 520 has a non-volatile storage area that stores programs and data in a non-volatile manner. The terminal storage section 520 may also have a volatile storage area to form a work area that temporarily stores programs to be executed by the terminal processor 510 and data to be processed.

The terminal network communication section 51 has communication hardware complying with a predetermined communication standard. Under control of the terminal control section 50, the terminal network communication section 51 communicates with devices coupled to the global network GN according to the predetermined communication standard. In this embodiment, the device, coupled to the global network GN, with which the terminal network communication section 51 communicates is the posting server 1.

The terminal communication section 52 is structured by communication hardware complying with a predetermined communication standard. Under control of the terminal control section 50, the terminal communication section 52 communicates with the printer 3. The communication standard for communication between the tablet terminal 5 and the printer 3 may be a wireless communication standard or may be a wired communication standard.

The touch panel 53 has a display panel such as a liquid crystal display panel, and also has a touch sensor disposed so as to be laminated on the display panel or formed integrally with the display panel. Under control of the terminal control section 50, the display panel displays various images. The touch sensor detects a touch manipulation and outputs a detection result to the terminal control section 50. The terminal control section 50 executes processing corresponding to the touch manipulation in response to the input from the touch sensor.

The GPS unit 54 has hardware used to periodically receive a GPS signal transmitted from a GPS satellite through a GPS antenna (not illustrated). The GPS unit 54 measures the distance between the tablet terminal 5 and the GPS satellite and the ratio of a change in the distance according to received GPS signals. This measurement is performed for at least a predetermined number of satellites to detect the current position of the tablet terminal 5. The current position, detected by the GPS unit 54, of the tablet terminal 5 is represented by, for example, the latitude and longitude of the tablet terminal 5. The GPS unit 54 outputs current position information indicating the current position of the tablet terminal 5 to the terminal control section 50.

The printer 3 has a printer control section 30, a printer communication section 31, and a printing section 32.

The printer control section 30 has a printer processor 310, which is a processor, such as a CPU or MPU, that executes programs, and also has a printer storage section 320. The printer control section 30 controls individual sections in the printer 3. To have the printer processor 310 read a control program 320A stored in the printer storage section 320 and execute processing, the printer control section 30 executes various types of processing in cooperation with hardware and software.

The printer storage section 320 has a storage area in which programs to be executed by the printer processor 310 and data to be processed by the printer processor 310 are stored. The printer storage section 320 stores the control program 320A to be executed by the printer processor 310 and various types of data. The printer storage section 320 has a non-volatile storage area that stores programs and data in a non-volatile manner. The printer storage section 320 may also have a volatile storage area to form a work area that temporarily stores programs to be executed by the printer processor 310 and data to be processed.

The printing section 32 has an ink jet head that discharges ink to a print medium to form dots, a carriage that moves the ink jet head in the scanning direction, a carriage driving motor that drives the carriage, a transport unit that transports the print medium, an ink tank from which ink is supplied to the ink jet head, and other constituent components involved in printing. The printing section 32 prints an image on a print medium under control of the printer control section 30. Particularly, the printing section 32 in this embodiment prints advertisement images KG on a print medium according to print data received from the posting server 1 through the tablet terminal 5 to issue a flyer TS.

Next, the operation of the advertisement system 100 will be described.

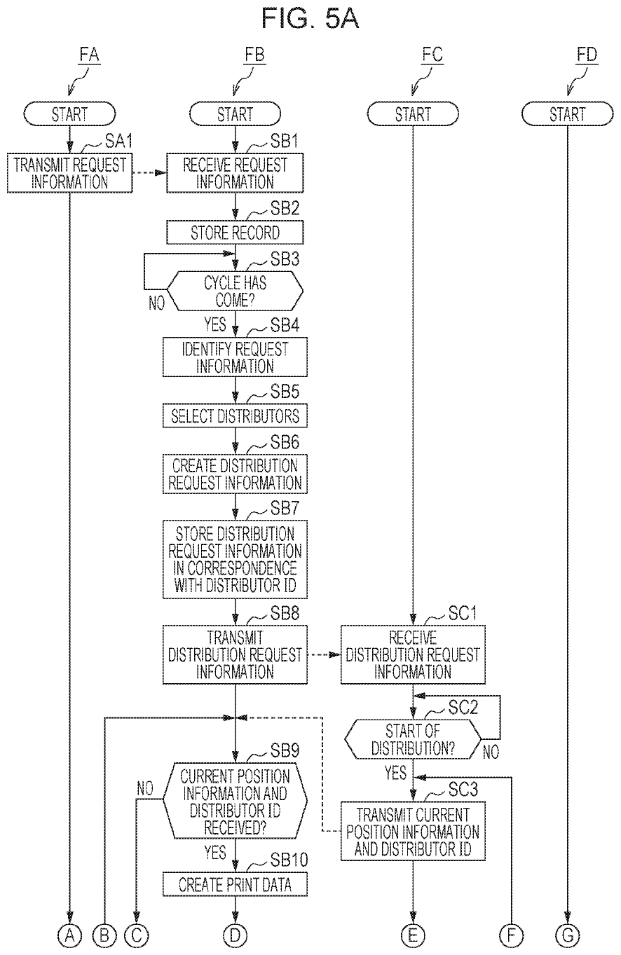

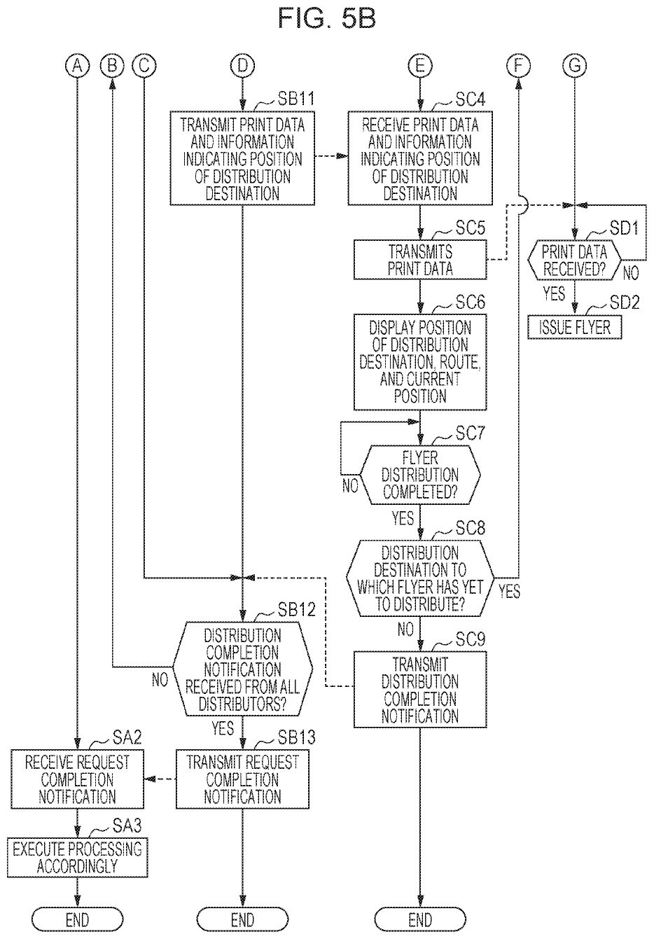

FIGS. 5A and 5B are flowcharts illustrating the operation of the advertisement system 100. In FIGS. 5A and 5B, the flowchart FA indicates the operation of the advertiser PC 2, the flowchart FB indicates the operation of the posting server 1, the flowchart FC indicates the operation of the tablet terminal 5, and the flowchart FD indicates the operation of the printer 3.

In the operation of the advertisement system 100 in FIGS. 5A and 5B, the posting server 1 requests, at predetermined intervals, the distributor 4 to distribute a flyer TS.

As indicated by the flowchart FA, the advertiser PC 2 transmits request information 12C2 to the posting server 1 in response to the manipulation by the advertiser 2A (step SA1).

Here, the operation of the advertiser PC 2 until request information 12C2 is transmitted to the posting server 1 will be described together with details of request information 12C2.

The advertiser 2A manipulates the advertiser PC 2 to activate the browser installed in the advertiser PC 2. The advertiser 2A then commands the advertiser PC 2 to access a Web page on which the advertiser 2A requests the distribution of a flyer TS. The advertiser 2A is notified of the uniform resource locator (URL) of the Web page in advance by a predetermined method.

After having accessed the URL, the advertiser PC 2 receives, from the posting server 1, a hypertext markup language (HTML) file that displays the Web page, and displays the Web page on the display panel according to the received HTML file.

On the displayed Web page, the advertiser 2A manipulates the advertiser PC 2 to enter information involved in a request for the distribution of a flyer TS.

In this embodiment, information involved in a request for the distribution of a flyer TS, the information being entered by the advertiser 2A, includes an advertiser ID 1221, address information 1222, advertisement image data 1223, distribution period information 1224, desired distribution count information 1225, desired distribution area information 1226, and distribution target information 1227.

The advertiser ID 1221 is identification information that identifies the advertiser 2A. The advertiser 2A is notified of the advertiser ID 1221 in advance by a predetermined method.

Address information 1222 is used to transmit predetermined information to the advertiser PC 2. An example of address information 1222 is a mail address or the like.

Advertisement image data 1223 is image data of an advertisement image KG representing an advertisement of the advertiser 2A. Advertisement image data 1223 is created by a predetermined application program installed in the advertiser PC 2.

Distribution period information 1224 indicates a distribution period for the flyer TS.

Desired distribution count information 1225 indicates a desired distribution count that is the number of copies of the flyer TS by which the advertiser 2A desires to make a distribution.

Desired distribution area information 1226 indicates a desired distribution area in which the distribution of the flyer TS is desired.

Distribution target information 1227 indicates a distribution target to which to distribute the flyer TS. Examples of the target are students, residents in apartments, and the like.

When the advertiser 2A has completed the entry of information involved in a request for the distribution of the flyer TS on the Web page, the advertiser PC 2 transmits, to the posting server 1, request information 12C2 indicating the request for the distribution of the flyer TS. This request information 12C2 includes advertisement cost information 1228, besides the information entered to the Web page by the advertiser 2A to request the distribution of the flyer TS. Advertisement cost information 1228 indicates an advertisement cost required for the distribution of the flyer TS. The advertisement cost is calculated by a function of the HTML file according to the entered information when the entry of information involved in a request for the distribution of the flyer TS is completed.

Referring again to FIGS. 5A and 5B, as indicated in the flowchart FB, when the server control section 10 in the posting server 1 receives request information 12C2 from the advertiser PC 2 (step SB1), the server control section 10 creates a record including the request information 12C2 and stores the created record in the request information management database 120C (step SB2).

Next, the server control section 10 decides whether a cycle in which to request the distributor 4 to distribute the flyer TS has come (step SB3).

When the server control section 10 decides that a cycle in which to request the distributor 4 to distribute the flyer TS has not yet come (No in step SB3), the server control section 10 makes a decision again in step SB3. When the server control section 10 receives request information 12C2 before the server control section 10 makes an affirmative decision in step SB3, the server control section 10 creates a record including the received request information 12C2 and stores the created record in the request information management database 120C.

When the server control section 10 decides that a cycle in which to request the distributor 4 to distribute the flyer TS has come (Yes in step SB3), the server control section 10 identifies request information 12C2 eligible for processing in this cycle from request information 12C2 stored in the request information management database 120C, according to the distribution period information 1224 in the request information 12C2 (step SB4).

It will be assumed that, for example, the posting server 1 requests, on a daily cycle basis, the distributor 4 to distribute a flyer TS. In this case, the server control section 10 identifies, from the request information management database 120C, request information 12C2 having distribution period information 1224 that includes one day on which a flyer TS will be distributed in this cycle.

Next, the server control section 10 selects distributors 4 for whom a request is to be made for the distribution of a flyer TS, according to the request information 12C2 identified in step SB4 (step SB5).

In step SB5, the server control section 10 selects, from the distributor management database 120B, distributors 4 to whom the desired distribution area indicated by the desired distribution area information 1226 is assigned as the assigned area TA for all pieces of request information 12C2 identified in step SB4. Processing to select a distributor 4 from the distributor management database 120B is specifically to select a record stored in the distributor management database 120B. It will be assumed that, for example, the server control section 10 identifies request information 12C2 having desired distribution area information 1226 that indicates any one of the area A, an area B, and an area C in step SB4. Then, the server control section 10 identifies one record from the request information management database 120C for each of the area A, area B, and area C. When there are a plurality of candidate records to be identified in one area, the server control section 10 identifies one from the plurality of candidate records according to a predetermined reference.

In processing step SB5 described above, the assigned area information 12B2 and desired distribution area information 1226 included in the request information 12C2 have been used as exemplary conditions to select a distributor 4. However, other various conditions may be additionally used to select a distributor 4. For example, in addition to the above selection based on the areas, the server control section 10 may consider the day or period during which the distributor 4 can distribute a flyer TS in the selection of a distributor 4 from the distributor management database 120B. In this case, the day or period during which the distributor 4 can distribute a flyer TS is stored in the posting server 1 in advance by the distributor 4 or posting agency 1A.

After having selecting the distributors 4, the server control section 10 creates distribution request information, which indicates a request to distribute a flyer TS, for each selected distributor 4 (step SB6).

The distribution request information created in step SB6 includes at least route information, distribution destination sequence information, and one or a plurality of pieces of distribution destination position information.

Route information indicates a route KR from a place of departure to the last destination in the distribution of a flyer TS by a distributor 4 in the assigned area TA of the distributor 4. The place of departure and the last destination may be each a distribution destination of the flyer TS or may be a place other than the distribution destinations.

Distribution destination sequence information indicates a sequence of distribution destinations to which the distributor 4 distributes the flyer TS in the assigned area TA of the distributor 4.

Distribution destination position information indicates the position of a distribution destination for the flyer TS in the assigned area TA of the distributor 4.

Here, processing in step SB6 will be described for a case in which distribution request information is created for the distributors 4 selected in step SB5. The server control section 10 references the map data 120D and extracts candidate distribution destinations in the assigned area TA of the distributor 4. The server control section 10 establishes the extracted candidates as the distribution destinations of the flyer TS. The server control section 10 references the map data 120D and determines a route KR passing through the established distribution destinations by a predetermined method. Along with the determination of the route KR, the server control section 10 also determines a sequence of the established distribution destination to which to distribute the flyer TS.

After having created distribution request information for each of the selected distributors 4, the server control section 10 stores the created distribution request information in the server storage section 120 in correspondence with the distributor ID 12B1 of the distributor 4 (step SB7).

Next, the server control section 10 transmits the distribution request information to the tablet terminal 5 of the relevant distributor 4 through the server network communication section 11 (step SB8).

Referring to the flowchart FC, the application executing section 5000 in the terminal control section 50 in the tablet terminal 5 receives the distribution request information through the terminal network communication section 51 (step SC1).

Next, the application executing section 5000 decides whether to start the destination of the flyer TS (step SC2).

When, for example, the separation distance between the current position detected by the GPS unit 54 and the position of the starting distribution destination in the sequence indicated by the distribution destination sequence information in the distribution request information is equal to or shorter than a predetermined distance, the application executing section 5000 makes an affirmative decision in step SC2. Also, when, for example, the application executing section 5000 detects a manipulation to command to start the distribution of the flyer TS on the touch panel 53, the application executing section 5000 makes an affirmative decision in step SC2.

When the application executing section 5000 decides to start the destination of the flyer TS (Yes in step SC2), the application executing section 5000 transmits the distributor ID 12B1 and current position information, which indicates the current position detected by the GPS unit 54, to the posting server 1 through the terminal network communication section 51 (step SC3). The distributor ID 12B1 is stored in advance in a predetermined storage area in the tablet terminal 5 by a function of the special app 520B.

Referring again to the flowchart FB, the server control section 10 decides whether the server network communication section 11 has received the distributor ID 12B1 and current position information from the tablet terminal 5 (step SB9). When transmission has been performed in step SC3, the server control section 10 makes an affirmative decision in step SB9.

When the server control section 10 makes a negative decision in step SB9, the server control section 10 causes the process to proceed to step SB12. When the server control section 10 makes an affirmative decision in step SB9, the server control section 10 creates print data involved in issuing a flyer TS to be distributed by the distributor 4, according to the received current position information and distribution destination sequence information included in distribution request information corresponding to the received distributor ID 12B1 (step SB10).

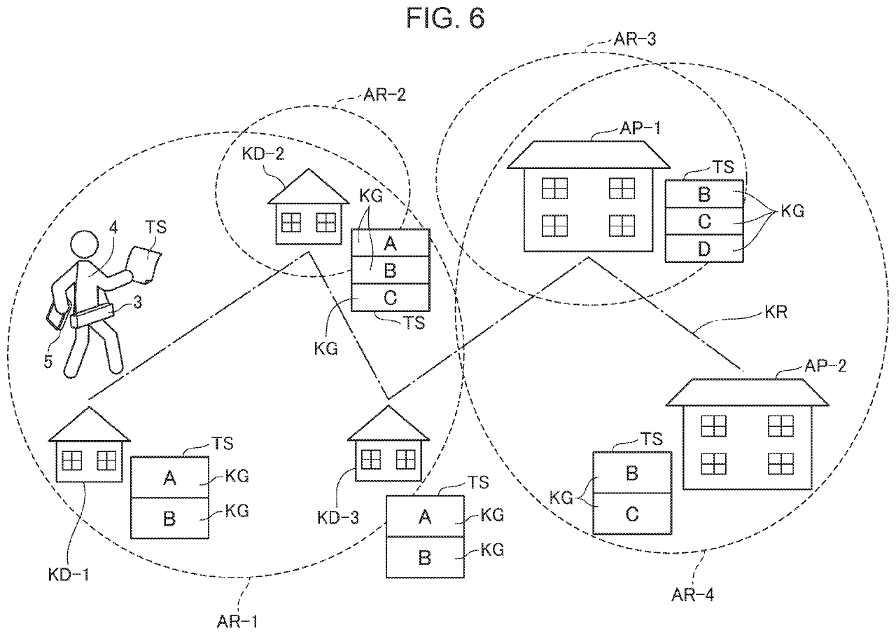

Processing performed in step SB10 by the server control section 10 will be described below in detail with reference to FIG. 6. When the separation distance between the current position indicated by the received current position information and the position of the starting distribution destination in the distribution destination sequence indicated by the distribution destination sequence information is equal to or shorter than a predetermined distance and print data involved issuing the flyer TS destined for the starting distribution destination has yet to be created, the server control section 10 creates print data involved issuing the flyer TS destined for the starting distribution destination. When the separation distance between the current position indicated by the received current position information and the position of the distribution destination at which the last distribution of a flyer TS was completed is equal to or shorter than a predetermined distance, the server control section 10 creates print data involved issuing a flyer TS destined for the next distribution destination, in the distribution destination sequence indicated by the distribution destination sequence information in the distribution request information, after the distribution destination at which the last distribution was completed.

After having created the print data, the server control section 10 transmits the created print data and information indicating the position of the distribution destination for the flyer TS to be issued according to the created print data to the tablet terminal 5 through the server network communication section 11 (step SB11).

Referring again to the flowchart FC, the application executing section 5000 in the tablet terminal 5 receives the print data and the information indicating the position of the distribution destination through the terminal network communication section 51 (step SC4).

Next, the application executing section 5000 transmits the print data received in step SC4 to the printer 3 through the terminal communication section 52 (step SC5).

Referring to the flowchart FD, the printer control section 30 in the printer 3 decides whether the print data has been received from the tablet terminal 5 (step SD1). When the tablet terminal 5 receives the print data from the tablet terminal 5 in step SC5, the printer control section 30 makes an affirmative decision in step SD1.

When the printer control section 30 decides that the print data has been received from the tablet terminal 5 (Yes in step SD1), the printer control section 30 controls the printing section 32 to have it execute printing based on the received data and issue a flyer TS (step SD2). The printer control section 30 then returns the process to step SD1.

Referring again to the flowchart FC, after having transmitted the print data to the printer 3, the application executing section 5000 displays, on the touch panel 53, distribution destination sequence information included in the distribution request information, route information included in the distribution request information, current position information indicating the current position of the tablet terminal 5, and the information indicating the distribution destination, the information having been received from the posting server 1 in step SC4 together with the print data (step SC6). Displaying distribution destination sequence information on the touch panel 53 is equivalent to an example of indicating distribution destination sequence information.

This display enables the distributor 4 to easily recognize the route KR and the distribution destination sequence through which to distribute flyers TS, so the flyers TS can be easily distributed in the assigned area TA. This display also enables the distributor 4 to easily recognize the distribution destinations to which to distribute flyers TS issued by the printer 3. This prevents the distributor 4 from distributing a flyer TS issued for a distribution destination to the wrong distribution destination.

Next, the application executing section 5000 decides whether the distribution of the flyer TS to the distribution destination has been completed (step SC7). For example, a button to establish the completion of the distribution of the flyer TS to the distribution destination is displayed on the touch panel 53. When the button is manipulated, the application executing section 5000 makes an affirmative decision in step SC7.

When the application executing section 5000 decides that the distribution of the flyer TS to the distribution destination has been completed (Yes in step SC7), the application executing section 5000 decides whether there is a distribution destination to which a flyer TS has yet to distribute (step SC8). The application executing section 5000 makes a decision in step SC8 according to the distribution destination position received from the posting server 1, the distribution destination sequence information included in the distribution request information, the route information included in the distribution request information, the current position information about the tablet terminal 5, and the like.

When the application executing section 5000 decides that there is a distribution destination to which a flyer TS has yet to distribute (Yes in step SC8), the application executing section 5000 returns the process to step SC3 and transmits again the distributor ID 12B1 and current position information, which indicates the current position detected by the GPS unit 54, to the posting server 1 through the terminal network communication section 51.

When the application executing section 5000 decides that there is no distribution destination to which a flyer TS has yet to distribute (No in step SC8), the application executing section 5000 transmits a distribution completion notification to the posting server 1 through the terminal network communication section 51, distribution completion notification indicating that flyers TS have been distributed to all distribution destinations (step SC9). This notification includes the distributor ID 12B1.

Now, the operation of the posting server 1 in steps SB9 to SB11 and the operation of the tablet terminal 5 in steps SC3 to SC9 will be specifically described with reference to FIG. 6.

FIG. 6 specifically illustrates the operations of the posting server 1 and tablet terminal 5.

A case will be exemplified in which the distributor 4 in FIG. 6 is the same person as the distributor 4 in FIG. 1 and the assigned area TA is the area A. In FIG. 6, it is exemplified that the distributor 4 distributes a flyer TS to five distribution destinations, houses KD-1, KD-2 and KD-3 and apartments AP-1 and AP-2. In FIG. 6, it is assumed that the server control section 10 has determined a route KR that passes through the houses KD-1, KD-2, and KD-3 and apartments AP-1 and AP-2, starting from the house KD-1 and terminating at the apartment AP-2, which is the last destination. In FIG. 6, it is also assumed that the server control section 10 has determined the sequence house KD-1, house KD-2, house KD-3, apartment AP-1, apartment AP-2 as the sequence of distribution destinations to which to distribute the flyer TS.

In FIG. 6, it is also assumed that, a house area AR-1, a new residential area AR-2, a student area AR-3, and an apartment area AR-4 are set in advance in the area A, which is the assigned area TA for the distributor 4, by the posting agency 1A. In the house area AR-1, at least a predetermined number of houses are present in each predetermined range. In the new residential area AR-2, at least a predetermined number of new houses are present in each predetermined range. In the student area AR-3, at least a predetermined number of students dwell in each predetermined range. In the apartment area AR-4, at least a predetermined number of apartments are present in each predetermined range. In FIG. 6, it is assumed that the houses KD-1, KD-2, and KD-3 are present in the house area AR-1. In FIG. 6, it is also assumed that the house KD-2 is present in the new residential area AR-2. In FIG. 6, it is also assumed that the apartment AP-1 is present in the student area AR-3. In FIG. 6, it is also assumed that the apartments AP-1 and AP-2 are present in the apartment area AR-4.

In FIG. 6, it is assumed that each piece of request information 12C2 from the advertisers 2A-1, 2A-2, 2A-3, and 2A-4 includes desired distribution area information 1226 indicating the area A. In FIG. 6, it is also assumed that the request information 12C2 from the advertiser 2A-1 includes distribution target information 1227 indicating residents in houses as a distribution target to which to distribute a flyer TS. It is also assumed that the request information 12C2 from the advertiser 2A-2 includes distribution target information 1227 indicating residents in houses and residents in apartments as distribution targets to which to distribute a flyer TS. It is also assumed that the request information 12C2 from the advertiser 2A-3 includes distribution target information 1227 indicating residents in apartments and residents in new houses as distribution targets to which to distribute a flyer TS. It is also assumed that the request information 12C2 from the advertiser 2A-4 includes distribution target information 1227 indicating student residents as a distribution target to which to distribute a flyer TS.

When the distributor 4 is present in the vicinity of the house KD-1 and starts to distribute a flyer TS, the tablet terminal 5 transmits current position information and the distributor ID 12B1 to the posting server 1 in step SC3. The posting server 1 decides that the distributor 4 is present in the vicinity of the house KD-1 according to the received current position information, and also decides that print data has yet to be created. Whether the distributor 4 is present in the vicinity of the house KD-1 is decided according to whether the separation distance between the current position of the tablet terminal 5 and the position of the house KD-1 is equal to or shorter than a predetermined distance. In step SB10, the server control section 10 creates print data involved in issuing a flyer TS intended for the house KD-1, which is the starting distribution destination. In this creation, the posting server 1 selects the advertisement images KG of the advertisers 2A-1 and 2A-2 indicating residents in houses as the distribution target because the house KD-1 is present in the house area AR-1. In FIG. 6, the advertisement image KG assigned the letter A is the advertisement image KG of the advertiser 2A-1, and the advertisement image KG assigned the letter B is the advertisement image KG of the advertiser 2A-2. The posting server 1 then creates print data involved in printing the advertisement images KG of the selected advertisers 2A-1 and 2A-2. The posting server 1 transmits the created print data to the printer 3 in step SB11. The tablet terminal 5 receives the print data and transmits the received print data to the printer 3 in step SC5. Then, in step SD2, the printer 3 issues a flyer TS on which the advertisement images KG of the advertisers 2A-1 and 2A-2 are printed as the flyer TS intended for the house KD-1, as illustrated in FIG. 6.

While confirming, on the tablet terminal 5, the current position of the tablet terminal 5 that the distributor 4 carries, the position of the house KD-1, the route KR through which to distribute flyers TS, and the distribution destination sequence, the distributor 4 distributes, to the house KD-1, the flyer TS intended for the house KD-1. In FIG. 6, it is assumed that the posting agency 1A has commanded the distributor 4 to make an entry to the tablet terminal 5 upon the completion of the distribution of a flyer TS to a distribution destination to indicate the completion. Therefore, when the distributor 4 has completed the distribution of the flyer TS to the house KD-1, the distributor 4 manipulates the tablet terminal 5 to make an entry to indicate the completion of the distribution of the flyer TS to the house KD-1.

Then, the tablet terminal 5 makes an affirmative decision in steps SC7 and SC8, and transmits the current position information and distributor ID 12B1 to the posting server 1 again. The posting server 1 decides that the distributor 4 is present in the vicinity of the house KD-1 according to the received current position information, and also decides that print data for the house KD-1 has been already created. The posting server 1 then decides, from the distribution destination sequence, that the next distribution destination after the house KD-1 is the house KD-2. In step SB10, the server control section 10 creates print data involved in issuing a flyer TS intended for the house KD-2. In this example, the house KD-1 is equivalent to an example of a first distribution destination, and the house KD-2 is equivalent to an example of a second distribution destination. In this creation, the posting server 1 selects the advertisement images KG of the advertisers 2A-1, 2A-2, and 2A-3 indicating at least one of residents in houses and residents in new houses as the distribution target because the house KD-2 is present in both the house area AR-1 and the new residential area AR-2. In FIG. 6, the advertisement image KG assigned the letter C is the advertisement image KG of the advertiser 2A-3. Next, the server control section 10 creates print data involved in printing the advertisement images KG of the selected advertisers 2A-1, 2A-2, and 2A-3. The posting server 1 transmits the created print data to the printer 3 in step SB11. Then, in step SD2, the printer 3 issues a flyer TS on which the advertisement images KG of the advertisers 2A-1, 2A-2, and 2A-3 are printed as the flyer TS intended for the house KD-2, as illustrated in FIG. 6.

While confirming, on the tablet terminal 5, the current position of the tablet terminal 5 that the distributor 4 carries, the position of the house KD-2, the route KR through which to distribute flyers TS, and the distribution destination sequence, the distributor 4 distributes the flyer TS to the house KD-2. As described above, in FIG. 6, the posting agency 1A has commanded the distributor 4 to make an entry to the tablet terminal 5 upon the completion of the distribution of a flyer TS to a distribution destination to indicate the completion. Therefore, when the distributor 4 has completed the distribution of the flyer TS to the house KD-2, the distributor 4 manipulates the tablet terminal 5 to make an entry to indicate the completion of the distribution of the flyer TS to the house KD-2.

Then, the tablet terminal 5 makes an affirmative decision in steps SC7 and SC8, and transmits the current position information and distributor ID 12B1 to the posting server 1 again. The posting server 1 decides that the distributor 4 is present in the vicinity of the house KD-2 according to the received current position information, and also decides that print data for the house KD-2 has been already created. The posting server 1 then decides, from the distribution destination sequence, that the next distribution destination after the house KD-2 is the house KD-3. Whether the distributor 4 is present in the vicinity of the house KD-2 is decided according to whether the separation distance between the current position of the tablet terminal 5 and the position of the house KD-2 is equal to or shorter than a predetermined distance. After having decided that the next distribution destination is the house KD-3, the server control section 10 creates print data involved in issuing a flyer TS intended for the house KD-3 in step SB10. In this example, the house KD-2 is equivalent to an example of the first distribution destination, and the house KD-3 is equivalent to an example of the second distribution destination. In this creation, the posting server 1 selects the advertisement images KG of the advertisers 2A-1 and 2A-2 indicating residents in houses as the distribution target because the house KD-3 is present in the house area AR-1. Next, the posting server 1 creates print data involved in printing the advertisement images KG of the selected advertisers 2A-1 and 2A-2. The posting server 1 transmits the created print data to the printer 3 in step SB11. Then, in step SD2, the printer 3 issues a flyer TS on which the advertisement images KG of the advertisers 2A-1 and 2A-2 are printed as the flyer TS intended for the house KD-3, as illustrated in FIG. 6.

While confirming, on the tablet terminal 5, the current position of the tablet terminal 5 that the distributor 4 carries, the position of the house KD-3, the route KR through which to distribute flyers TS, and the distribution destination sequence, the distributor 4 distributes the flyer TS to the house KD-3. When the distributor 4 has completed the distribution of the flyer TS to the house KD-3, the distributor 4 manipulates the tablet terminal 5 to make an entry to indicate the completion of the distribution of the flyer TS to the house KD-3.

Then, the tablet terminal 5 makes an affirmative decision in steps SC7 and SC8, and transmits the current position information and distributor ID 12B1 to the posting server 1 again. The posting server 1 decides that the distributor 4 is present in the vicinity of the house KD-3 according to the received current position information, and also decides that print data for the house KD-3 has been already created. The posting server 1 then decides, from the distribution destination sequence, that the next distribution destination after the house KD-3 is the apartment AP-1. Whether the distributor 4 is present in the vicinity of the house KD-3 is decided according to whether the separation distance between the current position of the tablet terminal 5 and the position of the house KD-3 is equal to or shorter than a predetermined distance. After having decided that the next distribution destination is the apartment AP-1, the server control section 10 creates print data involved in issuing a flyer TS intended for the apartment AP-1 in step SB10. In this example, the house KD-3 is equivalent to an example of the first distribution destination, and the apartment AP-1 is equivalent to an example of the second distribution destination. In this creation, the posting server 1 selects the advertisement images KG of the advertisers 2A-2, 2A-3, and 2A-4 indicating at least one of student residents and residents in apartments as the distribution target because the apartment AP-1 is present in both the student area AR-3 and the apartment area AR-4. Next, the posting server 1 creates print data involved in printing the advertisement images KG of the selected advertisers 2A-2, 2A-3, and 2A-4. The posting server 1 transmits the created print data to the printer 3 in step SB11. Then, in step SD2, the printer 3 issues a flyer TS on which the advertisement images KG of the advertisers 2A-2, 2A-3, and 2A-4 are printed as the flyer TS intended for the apartment AP-1, as illustrated in FIG. 6.

While confirming, on the tablet terminal 5, the current position of the tablet terminal 5 that the distributor 4 carries, the position of the apartment AP-1, the route KR through which to distribute flyers TS, and the distribution destination sequence, the distributor 4 distributes the flyer TS to the apartment AP-1. When the distributor 4 has completed the distribution of the flyer TS to the apartment AP-1, the distributor 4 manipulates the tablet terminal 5 to make an entry to indicate the completion of the distribution of the flyer TS to the apartment AP-1.

Then, the tablet terminal 5 makes an affirmative decision in steps SC7 and SC8, and transmits the current position information and distributor ID 12B1 to the posting server 1 again. The posting server 1 decides that the distributor 4 is present in the vicinity of the apartment AP-1 according to the received current position information, and also decides that print data for the apartment AP-1 has been already created. The posting server 1 then decides, from the distribution destination sequence, that the next distribution destination after the apartment AP-1 is the apartment AP-2. Whether the distributor 4 is present in the vicinity of the house apartment AP-1 is decided according to whether the separation distance between the current position of the tablet terminal 5 and the position of the apartment AP-1 is equal to or shorter than a predetermined distance. After having decided that the next distribution destination is the apartment AP-2, the server control section 10 creates print data involved in issuing a flyer TS intended for the apartment AP-2 in step SB10. In this example, the apartment AP-1 is equivalent to an example of the first distribution destination, and the apartment AP-2 is equivalent to an example of the second distribution destination. In this creation, the posting server 1 selects the advertisement images KG of the advertisers 2A-2 and 2A-3 indicating residents in apartments as the distribution target because the apartment AP-2 is present in the apartment area AR-4. Next, the posting server 1 creates print data involved in printing the advertisement images KG of the selected advertisers 2A-2 and 2A-3. The posting server 1 transmits the created print data to the printer 3 in step SB11. Then, in step SD2, the printer 3 issues the flyer TS on which the advertisement images KG of the advertisers 2A-2 and 2A-3 are printed as the flyer TS intended for the apartment AP-2, as illustrated in FIG. 6.

While confirming, on the tablet terminal 5, the current position of the tablet terminal 5 that the distributor 4 carries, the position of the apartment AP-2, and the route KR through which to distribute flyers TS, the distributor 4 distributes the flyer TS to the apartment AP-2. When the distributor 4 has completed the distribution of the flyer TS to the apartment AP-2, the distributor 4 manipulates the tablet terminal 5 to make an entry to indicate the completion of the distribution of the flyer TS to the apartment AP-2. Since there is no more next distribution destination to which to distribute a flyer TS after the apartment AP-2, the tablet terminal 5 makes an affirmative decision in step SC7 and a negative decision in step SC8. The tablet terminal 5 then transmits a distribution completion notification to the posting server 1 in step SC9.

In print data creation described with reference to FIG. 6, the server control section 10 selects advertisement images KG according to the area in which the distribution destination is present. However, this is not a limitation on the selection of advertisement images KG as long as advertisement images KG are selected according to the current position information received from the tablet terminal 5. For example, the server control section 10 may be structured so as to select advertisement images KG according to the advertisement cost indicated by advertisement cost information 1228 in request information 12C2, besides the selection described with reference to FIG. 6. Alternatively, for example, the server control section 10 may be structured so as to select advertisement images KG according to the desired distribution count indicated by desired distribution count information 1225 in request information 12C2, besides the selection described with reference to FIG. 6.

Referring again to the flowchart FB in FIGS. 5A and 5B, the server control section 10 in the posting server 1 decides whether distribution completion notification has been received from the tablet terminals 5 of all distributors 4 for whom a request was made in this cycle (step SB12).

When the server control section 10 decides that a distribution completion notification has not been received from the tablet terminals 5 of all distributors 4 (No in step SB12), the server control section 10 returns the process to step SB9. When the server control section 10 decides that a distribution completion notification has been received from the tablet terminals 5 of all distributors 4 (Yes in step SB12), the server control section 10 transmits a request completion notification to the relevant advertiser PC 2 according the address information 1222, the request completion notification indicating that the distribution, based on the request information 12C2, of the flyer TS had been completed in this cycle (step SB13).

Referring again to the flowchart FA, the advertiser PC 2 receives the request completion notification (step SA2) and executes processing corresponding to the reception of the request completion notification (step SA3). An example of the corresponding processing is processing to indicate that the distribution, based on the request information 12C2, of the flyer TS has been completed by, for example, using display panel.

Next a plurality of variations of the above embodiment will be described.

In a first variation, the posting server 1 transmits print data directly to the printer 3. In this arrangement, the printer 3 has communication hardware that is coupled to the global network GN and can be communicate with the posting server 1. In this arrangement, the posting server 1 does not transmit print data to the tablet terminal 5.

In a second variation, the printer 3 transmits current position information indicating the current position of the printer 3 to the posting server 1 as the current position of the distributor 4, instead of the tablet terminal 5. In this arrangement, the printer 3 has hardware, such as, for example, the GPS unit 54 included in the tablet terminal 5, that detects a current position. In this arrangement, the advertisement system 100 executes operations described below. That is, when the tablet terminal 5 decides to start the distribution of the flyer TS, the tablet terminal 5 indicates that the printer 3 is to be operated to transmit current position information about the printer 3 to the posting server 1. The distributor 4 commands the printer 3 to transmit current position information by, for example, using a manipulation panel. The printer 3 transmits current position information to the posting server 1. When the tablet terminal 5 decides that there is a distribution destination to which distribution has yet to be performed, the tablet terminal 5 indicates that the printer 3 is to be operated to transmit current position information about the printer 3 to the posting server 1. The distributor 4 commands the printer 3 to transmit current position information by, for example, using the manipulation panel. The printer 3 transmits current position information to the posting server 1.

In a third variation, the printer 3 has hardware, such as, for example, the GPS unit 54 included in the tablet terminal 5, that detects a current position, and also has functions of the terminal control section 50 described above. In this arrangement, the printer 3 transmits current position information indicating the current position of the printer 3 to the posting server 1, and upon receipt of print data for advertisements from the posting server 1, prints advertisement images KG.

As described above, through communication between the tablet terminal 5 and the posting server 1, the advertisement system 100 issues a flyer TS by using the printer 3, advertisement images KG being printed on the flyer TS. In the advertisement system 100, the tablet terminal 5 detects a current position and transmits current position information indicating the detected current position to the posting server 1. The posting server 1 receives the current position information from the printer 3 or tablet terminal 5, and selects advertisement images KG matching the current position indicated by the received current position information from a plurality of advertisement images KG acquired from advertisers 2A. The posting server 1 then creates print data involved in printing the selected advertisement images KG, and transmits the created print data to the tablet terminal 5. Upon receipt of the print data, the tablet terminal 5 causes the printer 3 to execute printing based on the received print data.

In a method of controlling the advertisement system 100, the tablet terminal 5 detects a current position and transmits current position information indicating the detected current position to the posting server 1. The posting server 1 receives the current position information from the printer 3 or tablet terminal 5 and selects advertisement images KG based on the current position indicated by the received current position information from a plurality of advertisement images KG acquired from advertisers 2A. The posting server 1 then creates print data involved in printing the selected advertisement images KG and transmits the created print data to the tablet terminal 5. Upon receipt of the print data, the tablet terminal 5 causes the printer 3 to execute printing based on the received print data.

The tablet terminal 5 has the GPS unit 54, the terminal control section 50, the terminal communication section 52 that communicates with the printer 3, and the terminal network communication section 51 that communicates with the posting server 1. The terminal control section 50 transmits current position information indicating the current position detected by the GPS unit 54 to the posting server 1 through the terminal network communication section 51. The terminal control section 50 receives print data involved in printing advertisement images KG from the posting server 1 through the terminal network communication section 51, the advertisement images KG being selected by the posting server 1 from a plurality of advertisement images KG according to the current position of the tablet terminal 5, the plurality of advertisement images KG being acquired from advertisers 2A. The terminal control section 50 then transmits the received print data to the printer 3 through the terminal communication section 52 to have the printer 3 execute printing based on the print data.

The special app 520B causes the terminal control section 50 to transmit current position information indicating the current position detected by the GPS unit 54 to the posting server 1 through the terminal network communication section 51. The special app 520B also causes the terminal control section 50 to receive print data involved in printing advertisement images KG from the posting server 1 through the terminal network communication section 51, the advertisement images KG being selected by the posting server 1 from a plurality of advertisement images KG according to the current position of the tablet terminal 5, the plurality of advertisement images KG being acquired from advertisers 2A. The special app 520B then causes the terminal control section 50 to transmit the received print data to the printer 3 through the terminal communication section 52.

According to the arrangements of the advertisement system 100, the method of controlling the advertisement system 100, the tablet terminal 5, and the special app 520B, it is possible to issue a flyer TS on which advertisements selected according to the current position of the tablet terminal 5 or printer 3 are placed. Therefore, when advertisements to be placed on a flyer TS are to be varied, there is no area restriction that would lead to the inability to vary advertisements to be placed on a flyer TS in, for example, the assigned area TA of the distributor 4. Therefore, the advertisement system 100, the method of controlling the advertisement system 100, the tablet terminal 5, and the special app 520B enable advertisements to be placed on a flyer TS to be varied in the distribution area of the flyer TS. In addition, since a flyer TS on which advertisements selected according to the current position of the tablet terminal 5 or printer 3 can be issued, it is possible to distribute a flyer TS including advertisements in which the distribution destination has a keen interest. Therefore, a flyer TS that is highly effective in advertisements can be distributed.

In the advertisement system 100, the posting server 1 determines a sequence of distribution destinations to which to distribute flyers TS. When the distribution of a flyer TS has been completed at a distribution destination, the printer 3 or tablet terminal 5 transmits current position information to the posting server 1. The posting server 1 creates print data for a flyer TS to be distributed to the next distribution destination after the distribution destination, according to the determined sequence of distribution destinations and the current position information received from the printer 3 or tablet terminal 5. A distribution destination is equivalent to the first distribution destination, and the next distribution destination after the distribution destination is equivalent to the second distribution destination.

According to this arrangement, a flyer TS to be distributed to the next distribution destination can be issued in advance. This can prevent a situation in which although the distributor 4 has already arrived at the next distribution destination, the distributor 4 has to wait for a flyer TS to be issued. The distributor 4 can efficiently distribute, to a plurality of distribution destinations, flyers TS on which advertisements different depending on the distribution destination are placed.

The posting server 1 transmits distribution destination sequence information indicating the determined sequence of distribution destinations to the tablet terminal 5. The tablet terminal 5 indicates the distribution destination sequence information.

According to this arrangement, the distributor 4 can distribute a flyer TS while confirming the sequence of distribution destinations to which to distribute the flyer TS. This can prevent the distributor 4 from distributing a flyer TS issued for a distribution destination to the wrong distribution destination.

The printer 3 includes hardware, such as, for example, the GPS unit 54 included in the tablet terminal 5, that detects a current position, and also includes a structure for executing functions of the terminal control section 50.

According to this arrangement, even when the printer 3 is structured so as to have hardware, such as, for example, the GPS unit 54 included in the tablet terminal 5, that detects a current position, and also include a structure that can execute functions of the tablet terminal 5, the printer 3 provides effects similar to the effects described above.

The embodiment and variations described above just indicate one aspect of the present disclosure. The embodiment and variations can be arbitrarily modified and applied without departing from the intended scope of the present disclosure.

For example, in the embodiment described above, the printer 3 has been exemplified by a printer of portable type. However, the printer 3 may be of stationary type. In this case, the distributor 4 disposes at least printer 3 in a moving body such as a vehicle and distributes a flyer TS to a distribution destination while moving the moving body.

For example, the posting server 1 may be structured so as to transmit information indicating a place in which distribution of a flyer TS is inhibited together with distribution request information. In this case, the posting server 1 manages the information indicating a place in which distribution of a flyer TS is inhibited in a manner in which the posting agency 1A can modify the information. This can prevent the distributor 4 from mistakenly distributing a flyer TS to a place in which distribution of a flyer TS is inhibited.

For example, in the embodiment and variations described above, the posting server 1 has transmitted print data to the tablet terminal 5 or printer 3. However, the posting server 1 may transmit flyer image data indicating one image to be printed on the entire surface of a flyer TS, instead of print data. The image indicated by flyer image data includes one or a plurality of advertisement images KG selected by the posting server 1. In this case, the application executing section 5000 or the printer control section 30 in the printer 3 create print data used to issue a flyer TS, according to the received flyer image data.

Functions of the server control section 10, terminal control section 50, and printer control section 30 may be implemented by a plurality of processors or a semiconductor chip.

The sections illustrated in FIG. 2 are just an example. There is no particular limitation on a specific mounting method. That is, one piece of hardware does not necessarily need to be mounted in correspondence with one section. Of course, it is possible for one processor to execute programs to implement functions of individual sections. Furthermore, part of the functions implemented by software in the embodiment described above may be implemented by hardware. Alternatively, part of the functions implemented by hardware may be implemented by software. In addition, specific details of the structures of the posting server 1, tablet terminal 5, printer 3, and other sections can also be arbitrarily modified without departing from the intended scope of the present disclosure.

For example, the flowcharts in FIGS. 5A and 5B have been divided into operation steps according to main processing, so as to facilitate the understanding of the operations of each apparatus in the advertisement system 100. The present disclosure is not limited by the method of dividing a single piece of processing into steps or by a name. The flowcharts may be divided into more steps according to the processing. One step may be further divided so as to include more processing. The sequence of steps may be appropriately changed without causing a problem in the intended scope of the present disclosure.

What is claimed is:

1. An advertisement system in which a server and a control apparatus that controls a printing apparatus mutually communicate to issue an advertisement medium by using the printing apparatus, an advertisement image being printed on the advertisement medium, wherein:
the control apparatus detects a current position and transmits current position information indicating the detected current position to the server;
the server receives the current position information from the control apparatus, selects an advertisement image based on the current position indicated by the received current position information from a plurality of advertisement images acquired from an advertiser, creates print data involved in printing the selected advertisement image, and transmits the created print data to the control apparatus; and
upon receipt of the print data, the control apparatus causes the printing apparatus to execute printing based on the received print data.

2. The advertisement system according to claim 1, wherein:
the server determines a sequence of distribution destinations to which to distribute the advertisement medium;
when distribution of the advertisement medium was completed at a first distribution destination, the printing apparatus or the control apparatus transmits the current position information to the server; and
the server creates the print data for the advertisement medium to be distributed to a second distribution destination, which is a next distribution destination after the first distribution destination, according to the determined sequence and the current position information received from the printing apparatus or the control apparatus.

3. The advertisement system according to claim 2, wherein:
the server transmits information indicating the determined sequence to the control apparatus; and
the control apparatus indicates the information indicating the sequence.

4. The advertisement system according to claim 1, wherein the printing apparatus includes the control apparatus.

5. A control apparatus that controls a printing apparatus, the control apparatus comprising:
a first communication section that communicates with the printing apparatus;
a second communication section that communicates with a server;
a position detecting section that detects a current position; and
a control section that controls the first communication section, the second communication section, and the position detecting section; wherein
the control section
transmits current position information indicating the current position detected by the position detecting section to the server through the second communication section,
receives print data from the server through the second communication section, the print data being involved in printing an advertisement image selected by the server from a plurality of advertisement images acquired from an advertiser according to the current position, and
transmits the received print data to the printing apparatus through the first communication section to have the printing apparatus execute printing based on the print data.

6. A non-transitory computer-readable storage medium storing a program executable by a control section in a control apparatus having a first communication section that communicates with a printing apparatus, a second communication section that communicates with a server, and a position detecting section that detects a current position; wherein the program causes the control section
to transmit current position information indicating the current position detected by the position detecting section to the server through the second communication section,
to receive print data from the server through the second communication section, the print data being involved in printing an advertisement image selected by the server from a plurality of advertisement images acquired from an advertiser according to the current position, and
to transmit the received print data to the printing apparatus through the first communication section.
